(19) United States
(12) Patent Application Publication
(10) Pub. No.: US 2020/0369152 A1
(43) Pub. Date: Nov. 26, 2020

(54) DIGITAL COCKPIT DISPLAY

(71) Applicant: Dr. Ing. h.c. F. Porsche Aktiengesellschaft, Stuttgart (DE)

(72) Inventors: Dominik Hoeschle, Stuttgart (DE); Jan-Niklas Helbach, Asperg (DE); Houssam Habib, Stuttgart (DE); Matthias Braun, Ludwigsburg (DE); Marcel Straub, Remseck (DE)

(21) Appl. No.: 16/882,785

(22) Filed: May 26, 2020

(30) Foreign Application Priority Data
May 23, 2019 (DE) 10 2019 113 784.5

(51) Int. Cl. B60K 35/00; G09G 5/02

(52) U.S. Cl. CPC B60K 35/00; G09G 5/02; B60K 2370/167; G09G 2380/12; B60K 2370/164; B60K 2370/152; B60K 2370/52; B60K 2370/166

(57) ABSTRACT

A digital cockpit display (1) for a vehicle has a display device (2) with electronic display elements (3a-3n) arranged in the form of a matrix and by means of which information can be visualized. A control device (4) enables control of the display elements (3a-3n) to visualize the information. The display device (2) has micro-electromechanical actuators (5a-5n) that are connected to the display elements (3a-3n) and are selectively controllable by the control device (4) so that they initiate a linear movement of the display elements (3a-3n) between a retracted position in which a longitudinal extension of the microelectronic actuators (5a-5n) is minimal and a fully extended position in which the longitudinal extension of the microelectronic actuators (5a-5n) is maximal.

### CROSS REFERENCE TO RELATED APPLICATION

This application claims priority under 35 USC 119 to German Patent Appl. No. 10 2019 113 784.5 filed on May 23, 2019, the entire disclosure of which is incorporated herein by reference.

### BACKGROUND

### Field of the Invention

The invention relates to a digital cockpit display for a vehicle, comprising a display device with electronic display elements arranged in the form of a matrix and by means of which information can be visualized, and a control device by means of which the display elements are controllable to visualize the information.

### Related Art

Round analog instruments were common in vehicle passenger compartments until a few years ago to indicate to the driver, for example, the present vehicle speed, the rotational speed of a drive device of the motor vehicle and further information. The analog instruments increasingly are being replaced with digital cockpit displays. These digital cockpit displays comprise a display device with electronic display elements arranged in the form of a matrix that enables information to be visualized, and a control device that controls the display elements to visualize the information. Digital cockpit displays of this type advantageously are configurable so that the scope of the presented information and the visual appearance of the information reproduction can be adapted to the personal needs of the driver. Thus, the information displayed by the digital cockpit display can be presented in a very clear manner.

Despite colored display effects, cockpit displays of this type have no three-dimensional depth effect of the type known, for example, from round analog instruments. To tackle this problem, some vehicle manufacturers already offer digital cockpit displays in specific model ranges with fixed three-dimensional elements arranged in a field of view on the display device to provide a three-dimensional depth effect visible to a viewer. These digital cockpit displays are similarly configurable so that it is possible, for example, to adapt the scope of the information presented and the visual appearance of the information reproduction to the personal needs of the driver. The information displayed by means of the digital cockpit display similarly can be presented in a very clear manner. However, the fixed arrangement of the three-dimensional elements has the disadvantage that the design freedom to modify the visual appearance of a digital cockpit display of this type is restricted severely, since the three-dimensional elements form information presentation areas whose design cannot be changed.

DE 10 2017 209 268 A1 discloses a display system with display segments and a flat, elastically designed display support. The elastic display support can be subjected to a force and can be deformed so that the relative positions of at least two display segments can be changed.

The object of the present invention is to provide a digital cockpit display that enables three-dimensional-looking depth effects to be created in a simple manner.

### SUMMARY

A digital cockpit display according to the invention is characterized in that the display device has micro-electromechanical actuators that are connected to the display elements and that are selectively controllable by the control device in such a way that they initiate a linear movement of the display elements between a retracted position in which a longitudinal extension of the microelectronic actuators is minimal and a fully extended position in which the longitudinal extension of the microelectronic actuators is maximal. Along with the actual display of information by means of the display device, the micro-electromechanical actuators, also often referred to as micro-electromechanical systems (MEMS for short), enable a selective and reversible creation of three-dimensional depth effects. Thus, the corresponding display elements are moved selectively from a retracted position into a fully or at least partially extended position and therefore toward the viewer. This technique, for example, enables three-dimensional, circular borders of conventional round instruments to be simulated on the display device of the digital cockpit display. The information that can be visualized by means of the display device can include, for example, the present vehicle speed, the rotational speed of a drive device of the motor vehicle, present operating and/or environment parameters, navigation information and multimedia information, as well as other information. The display device may be be configurable in relation to the displayed information and the three-dimensional depth effects. The scope of the information presented and the visual appearance of the information reproduction, particularly with regard to the three-dimensional depth effects can be adapted to the personal needs of the driver. The micro-electromechanical actuators can, for example, also be controlled by the control device in such a way that the positions of at least some of the display elements are changed over time so that three-dimensional animations can be generated.

In one embodiment, plural display elements are assigned to one of the micro-electromechanical actuators. In other words, in this embodiment, a single actuator enables a simultaneous linear movement of plural display elements.

In an alternate embodiment, one micro-electromechanical actuator can be assigned to each display element. Thus, a single actuator enables the linear movement of a single display element assigned to the relevant actuator so that three-dimensional depth effects can be created with a very high local resolution.

The display device may have a retaining surface to which the micro-electromechanical actuators are fit. This retaining surface may form a reference surface for the linear movement of the micro-electromechanical actuators by means of which the display elements can be moved selectively.

The retaining surface can be formed by a rear side of the display device. In this embodiment, the rear side of the display device forms the reference surface for the linear movement of the display elements.

The display elements can be pixel elements.

The display elements can be multicolored TFT pixel elements. The display elements can be designed, for example, as three-colored RGB-TFT pixel elements.

The micro-electromechanical actuators may be controllable so that at least some of the display elements are moved selectively into an intermediate position between the retracted position in which the longitudinal extension of the micro-electromechanical actuators is minimal and the fully extended position in which the longitudinal extension of the micro-electromechanical actuators is maximal. The intermediate positions can be identical or at least partially different for the relevant display elements. It is thus advantageously possible for the display elements to be moved not only from the fully retracted position into the fully extended position, but also into different intermediate positions between these positions. As a result, gradual three-dimensional depth effects can be created.

Further features and advantages of the invention will become evident from the following description of one embodiment.

### BRIEF DESCRIPTION OF THE DRAWINGS

FIG. 1 shows a part of a digital cockpit display 1 for a vehicle in a schematically highly simplified form.

### DETAILED DESCRIPTION

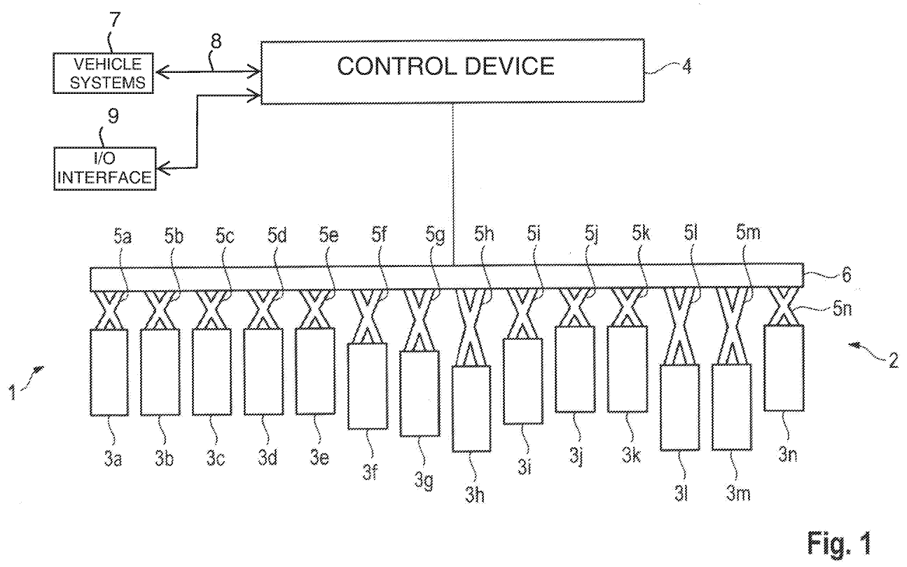

The digital cockpit display 1 comprises a display device 2 with electronic display elements 3a-3n by means of which information can be visualized for a driver of the vehicle. The electronic display elements 3a-3n are arranged in a two-dimensional, matrix-like structure, wherein only a single row with a total of n display elements 3a-3n has been shown for reasons of simplicity in FIG. 1. These display elements 3a-3n can be multicolored pixel elements, in particular three-colored TFT-RGB pixel elements.

The digital cockpit display 1 further has a control device 4 by means of which the display elements 3a-3n are controllable in such a way that they can display different information to a driver. This information can include, for example, the present vehicle speed, the rotational speed of a drive device of the motor vehicle, present operating and/or environment parameters, navigation information and multimedia information. This list is obviously not exhaustive and can be extended to include any other visually presentable information.

The display device 2 has a retaining surface 6 to which the display elements 3a-3n are fit using micro-electromechanical actuators 5a-5n. This retaining surface 6 can be a rear side of the display device 2. The micro-electromechanical actuators 5a-5n also are controlled by the control device 4 and are designed so that they initiate a linear movement of the display elements 3a-3n between a retracted position in which a longitudinal extension of the micro-electromechanical actuators 5a-5n is minimal and a fully extended position in which the longitudinal extension of the microelectronic actuators 5a-5n is maximal. One of the microelectronic actuators 5a-5n that can initiate the linear movement of the relevant display element 3a-3n is assigned in each case to each of the display elements 3a-3n. Thus, three-dimensional depth effects with a high local resolution can be created. However, embodiments are also possible in which a single micro-electromechanical actuator 5a-5n is assigned to a plurality of display elements 3a-3n so that said display elements can be moved simultaneously by means of the relevant micro-electromechanical actuator 5a-5n. The number of micro-electromechanical actuators 5a-5n can be reduced as a result.

As is evident from FIG. 1, the micro-electromechanical actuators 5a-5n selectively controllable by the control device 4 enable the creation of three-dimensional depth effects whereby some of the display elements 3a-3n are moved away from the retaining surface 6 of the display device 2, which to some extent forms a reference surface, and therefore toward the viewer, whereas other display elements 3a-3n remain in their starting position in which the associated micro-electromechanical actuators 5a-5n in a retracted position have their minimal longitudinal extension. In the representation shown in FIG. 1, the display elements denoted with the reference numbers 3a-3e, 3j, 3k and 3n are in the starting position in which the associated micro-electromechanical actuators 5a-5e, 5j, 5k and 5n are not activated. The display elements denoted with the reference numbers 3h, 31 and 3m are in a maximum possible raised position in relation to the retaining surface 6. The remaining display elements denoted with the reference numbers 3f, 3g and 3i are in each case in an intermediate position between the starting position and the maximum possible extended position. Gradual three-dimensional depth effects can advantageously be created due to the differently raised positions of the display elements 3a-3n. Embodiments in which the display elements 3a-3n can selectively assume only the starting positions and maximum raised positions are essentially also conceivable. The control of the associated microelectronic and actuators 5a-5n is then simpler, but does not enable the creation of gradual, three-dimensional depth effects.

By means of the technique described above, for example, three-dimensional, circular borders of conventional round instruments can be simulated on the display device 2 of the digital cockpit display 1.

The microelectronic actuators 5a-5 can, for example, also be controlled by the control device 4 in such a way that the positions of the display elements 3a-3n are changed over time so that three-dimensional animations can be generated.

What is claimed is:

1. A digital cockpit display for a vehicle, comprising a display device with electronic display elements that are arranged in the form of a matrix and that enable information to be visualized information. A control device controls the display elements to visualize the information, the display device having micro-electromechanical actuators connected to the display elements and being selectively controllable by the control device to initiate a linear movement of the display elements between a retracted position in which a longitudinal extension of the microelectronic actuators is minimal and a fully extended position in which the longitudinal extension of the microelectronic actuators is maximal.

2. The digital cockpit display of claim 1, wherein at least one of the micro-electromechanical actuators is assigned to a plurality of the display elements.

3. The digital cockpit display of claim 1, wherein each of the micro-electromechanical actuators is assigned respectively to a single one of the display elements.

4. The digital cockpit display of claim 1, wherein the display device has a retaining surface to which the microelectronic actuators are fit.

5. The digital cockpit display of claim 4, wherein the retaining surface is formed by a rear side of the display device.

6. The digital cockpit display of claim 1, wherein the display elements are pixel elements.

7. The digital cockpit display of claim 6, wherein the display elements are multicolored TFT pixel elements.

8. The digital cockpit display of claim 1, wherein the micro-electromechanical actuators are controllable in such a way that at least some of the display elements are moved into an intermediate position between the retracted position in which the longitudinal extension of the microelectronic and actuators is minimal and the fully extended position in which the longitudinal extension of the microelectronic actuators is maximal.
